(19) United States
(12) Patent Application Publication
(10) Pub. No.: US 2025/0282597 A1
(43) Pub. Date: Sep. 11, 2025

(54) SCISSOR LINKAGE

(71) Applicant: TEREX SOUTH DAKOTA, INC., Watertown, SD (US)

(72) Inventors: Dong CAO, Changzhou, Jiangsu (CN); Beau BROWN, Redmond, WA (US); Chad HISLOP, Redmond, WA (US); Michael DAVIS, Redmond, WA (US); Kai WANG, Changzhou, Jiangsu (CN); Ling ZHANG, Changzhou, Jiangsu (CN); Hongdong ZHANG, Changzhou, Jiangsu (CN); Hao LIN, Changzhou, Jiangsu (CN); Daifeng ZHANG, Changzhou, Jiangsu (CN); Wenjia WANG, Changzhou, Jiangsu (CN); Xiaocheng YANG, Changzhou, Jiangsu (CN)

(73) Assignee: TEREX SOUTH DAKOTA, INC., Watertown, SD (US)

(21) Appl. No.: 18/858,678

(22) PCT Filed: May 19, 2022
(86) PCT No.: PCT/CN2022/093734

§ 371 Date: Oct. 21, 2024

Related U.S. Application Data
(63) Continuation-in-part of application No. PCT/CN2022/088153, filed on Apr. 21, 2022.

(51) Int. Cl. B66F 11/04

(52) U.S. Cl. CPC B66F 11/042

(57) ABSTRACT

A scissor linkage according to the disclosure may include a first support member including a first central portion and a first end portion having a first end pivot location. The first support member may further include at least one bend so that the first end portion is offset with respect to a longitudinal axis that extends through the first central portion. In addition, the scissor linkage may include a second support member having a second end portion attached to the first end portion of the first support member at the first end pivot location of the first support member so that the second support member is pivotable about a pivot axis that extends through the first end pivot location of the first support member.

### CROSS REFERENCE OF RELATED APPLICATION

The present application claims a priority of the PCT Application PCT/CN2022/088153 filed on Apr. 21, 2022, which is incorporated herein by reference in its entirety.

### TECHNICAL FIELD

The disclosure relates to a scissor linkage, a lift device including a scissor linkage, and a method of making a scissor linkage.

### BACKGROUND

A prior scissor linkage may include a series of linked, foldable support members that each have a main support member body and a pivot support structure welded at each end of the support member body. The pivot support structures of adjacent support members are connected together so that the adjacent support members are pivotable with respect to each other.

An example of a prior scissor linkage is disclosed in U.S. Patent Application Publication No. 2021/0354968 A1.

### SUMMARY

A scissor linkage according to the disclosure may include a first support member including a first central portion and a first end portion having a first end pivot location. The first support member may further have at least one bend so that the first end portion is offset with respect to a longitudinal axis that extends through the first central portion. In addition, the scissor linkage may include a second support member having a second end portion attached to the first end portion of the first support member at the first end pivot location of the first support member so that the second support member is pivotable about a pivot axis that extends through the first end pivot location of the first support member. A lift device according to the disclosure may include a base and a scissor linkage

attached to the base and movable between a retracted position and an extended position. The scissor linkage may include first and second pairs of crisscrossed support members, wherein each support member of the first pair of crisscrossed support members has a first end portion having a first end pivot location, and a first central portion having a first height and a first central pivot location. The first central pivot locations of the first pair of crisscrossed support members may be attached together so that each support member of the first pair of crisscrossed support members is pivotable about a first central pivot axis that extends through the first central pivot locations. Each of the support members of the second pair of crisscrossed support members may have a second end portion that is attached to the first end portion of a respective support member of the first pair of crisscrossed support members at the first end pivot location of the respective support member so that each of the support members of the second pair of crisscrossed support members is pivotable about a pivot axis that extends through the first end pivot location of the respective support member of the first pair of crisscrossed support members. Furthermore, each support member of the first pair of crisscrossed support members may be bent so that, when the lift device is on level ground and the scissor linkage is in the retracted position, the pivot axis of each first end pivot location of the first pair of crisscrossed support members is offset with respect to a horizontal plane that extends through the first central pivot axis by a distance in a range of 40 percent to 70 percent of the first height. In addition, the lift device may include a platform attached to the scissor linkage, wherein the platform is movable with respect to the base between a lowered position and a raised position when the scissor linkage moves between the retracted position and the extended position.

A method according to the disclosure of making a scissor linkage may include bending a first support member having a first central portion and a first end portion so that the first end portion is offset with respect to a longitudinal axis that extends through the first central portion, wherein the first end portion defines a first end pivot location. The method may further include attaching a second support member to the first end portion of the first support member at the first end pivot location so that the second support member is pivotable with respect to the first support member about a pivot axis that extends through the first end pivot location.

While exemplary embodiments are illustrated and disclosed, such disclosure should not be construed to limit the claims. It is anticipated that various modifications and alternative designs may be made without departing from the scope of the disclosure.

### BRIEF DESCRIPTION OF THE DRAWINGS

FIG. 1 is a side view of a lift device including a base, a lifting mechanism or scissor linkage according to the disclosure coupled to the base, and a support assembly or work platform assembly coupled to an upper end of the scissor linkage, wherein the scissor linkage is shown in a stowed or retracted position;

FIG. 2 is a side view of the lift device of FIG. 1 showing the scissor linkage in a deployed or extended position;

FIG. 3 is a perspective view of the scissor linkage of FIG. 1 in the stowed position;

FIG. 4 is a perspective view of the scissor linkage of FIG. 1 in the deployed position;

FIG. 5 is a partial, perspective view of portions of two support members of the scissor linkage pivotally connected together;

FIG. 6 is a perspective view of an example support member of the scissor linkage;

FIG. 7 is a side, cross-sectional view of the support member shown in FIG. 6;

FIG. 8 is a side, cross-sectional view of another example embodiment of a support member according to the disclosure;

FIG. 9 is a side, cross-sectional view of yet another example embodiment of a support member according to the disclosure; and

FIG. 10 is a side, cross-sectional view of still yet another example embodiment of a support member according to the disclosure.

### DETAILED DESCRIPTION

As required, detailed embodiments are disclosed herein; however, it is to be understood that the disclosed embodiments are merely exemplary and that various and alternative forms may be employed. The figures are not necessarily to scale; some features may be exaggerated or minimized to show details of particular components. Therefore, specific structural and functional details disclosed herein are not to be interpreted as limiting, but merely as a representative basis for teaching one skilled in the art.

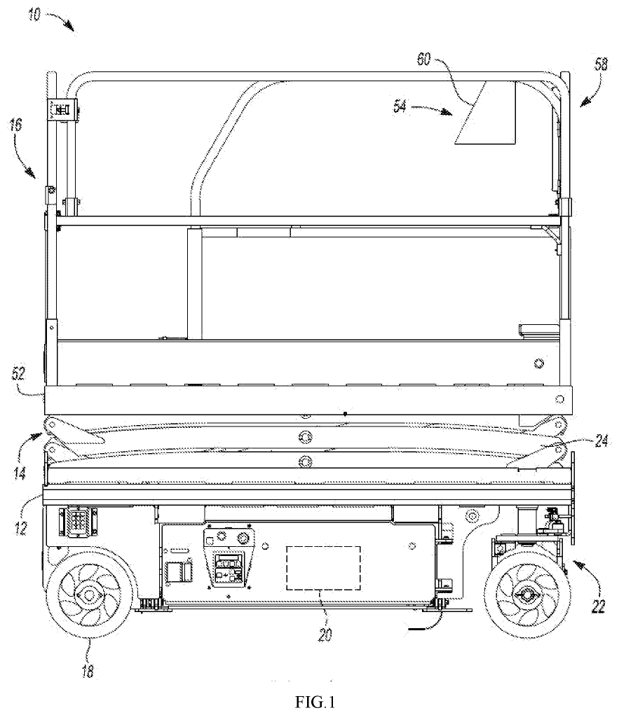

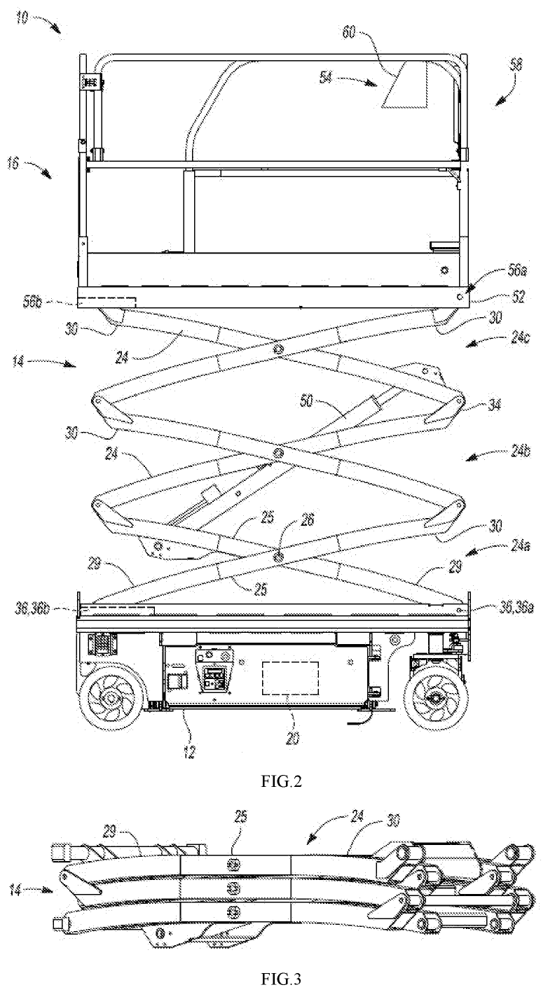

FIGS. 1 and 2 show a lift device 10, such as an aerial work platform, according to the disclosure. In the illustrated embodiment, the lift device 10 is formed as a scissor lift, having a base 12, a retractable lifting assembly or scissor linkage 14 connected to base 12, and a support assembly, such as work platform assembly 16, connected to the scissor linkage 14. The scissor linkage 14 is movable relative to the base 12 between a stowed or retracted position, shown in FIG. 1, and a deployed or extended position, shown in FIG. 2, as well as to various positions located between the retracted position and the extended position, in order to move the work platform assembly 16 to any one of multiple desired use positions. Furthermore, the scissor linkage 14 has a novel configuration as explained below in greater detail.

The lift device 10 may be configured as a movable vehicle, for example. In that regard, the base 12 may be a vehicle body, frame or chassis, and the lift device 10 may be provided with one or more wheels 18, or other movement facilitating members such as tracks, movably coupled to the base 12. One or more of the wheels 18 (e.g., front wheels), or other movement facilitating members, may be driven by any suitable drive system 20, such as a combustion engine, one or more electric motors, etc., and directed by a steering system 22 so that the lift device 10 may be positioned at a desired location. Although the drive system 20 is schematically shown in FIGS. 1 and 2 as a single unit, the drive system 20 may include any suitable number of units (e.g., engines or motors). For example, the drive system 20 may include a separate electric motor provided for each front wheel 18, or a separate electric motor may be provided for each front wheel 18 and each rear wheel 18.

In another embodiment, the lift device 10 may be a stationary device. In such a case, the base 12 may be configured as a stationary support structure, for example.

Referring to FIGS. 1-4, the scissor linkage 14 is attached (e.g., directly or indirectly) to the base 12 in any suitable manner, and may be formed of a series of multiple linked, foldable support members 24, such as rigid elements or arms like tubes, bars, rods, etc., that are cooperable with each other to enable the scissor linkage 14 to move between the retracted and extended positions. In the illustrated embodiment, the scissor linkage 14 includes two groups or sets of such support members 24, with one set on each side (e.g., right and left sides) of the lift device 10. Furthermore, each set may include one or more pairs of crisscrossed support members 24, and intermediate or central portions 25 of the support members 24 of each pair may be pivotally connected together using any suitable connection member, such as an intermediate or central pivot pin 26, that joins together central pivot locations 27 of the central portions 25 so that the support members 24 of each pair are pivotable with respect to each other about a central pivot axis 28 (shown in FIG. 4) that extends through the central pivot locations 27. Referring to FIG. 4, for example, each set may include first, second and third pairs 24a, 24b, and 24c, respectively, of crisscrossed support members. In another embodiment, each set may include two pairs of crisscrossed support members, or more than three pairs of crisscrossed support members. In yet another embodiment, the scissor linkage 14 may include a single set of support members 24, and the set may include any suitable number of crisscrossed support members, such as one, two, three or more pairs of crisscrossed support members.

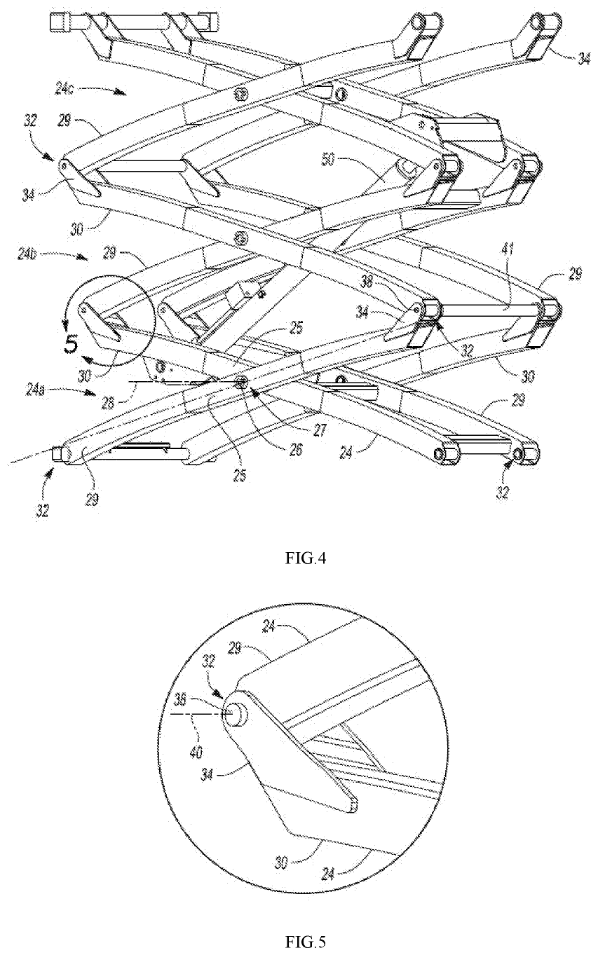

Referring to FIGS. 2-4, each support member 24 has first and second end portions 29 and 30, respectively, on opposite sides of the central portion 25 of the support member 24, and one or both of the end portions 29 and 30 may be offset with respect to the central portion 25. In that regard, each support member 24 may be bent (e.g., includes at least one bend) so that one or both of the end portions 29 and 30 may be offset (e.g., offset transversely) with respect to a longitudinal axis that extends through the central portion 25. In the embodiment shown in FIGS. 2-4, each of the end portions 29 and 30 of each of the support members 24 is bent with respect to the central portion 25 of the support member 24. Furthermore, referring to FIG. 5, each bent first end portion 29 defines a pivot location (e.g., end pivot location) 32, such as an opening or other connection point, that is attachable to the base 12, the work platform assembly 16, or to the second end portion 30 of a respective, e.g., adjacent, support member 24. In addition, a pivot support structure 34 is attached to each bent second end portion 30, such as by welding or with any suitable fasteners, and each pivot support structure 34 may include any suitable structure for pivotal attachment to the base 12, the work platform assembly 16, or to the first end portion 29 of a respective, e.g., adjacent, support member 24. For example, each pivot support structure 34 may include a bracket (e.g., metal or composite bracket) for receiving a pivot connector, such as a pivot pin, a roller or a slider. In the embodiment shown in FIG. 5, the pivot support structure 34 includes two metal (i.e., metal or metal alloy, such as aluminum, aluminum alloy, steel, stainless steel, etc.) side portions that are welded to the second end portion 30 of a respective support member 24, and the side portions form a receptacle for receiving the first end portion 29 of an adjacent support member 24. As another example, each pivot structure 34 may be made as a single piece (e.g., single piece of metal or metal alloy, such as cast steel or cast iron).

The upright lines shown in FIGS. 2-4 between the end portions 29, 30 and the central portion 25 of each support member 24 are provided to help distinguish between the portions, and not necessarily to indicate separate pieces joined together. In that regard, as explained below, the end portions 29, 30 and the central portion 25 of each support member 24 may be made as one piece.

In the embodiment shown in FIG. 4, each first end portion 29 forms a lower end portion of the corresponding support member 24 when the scissor linkage 14 is in the extended position, and each second end portion 30 forms an upper end portion of the corresponding support member 24 when the scissor linkage 14 is in the extended position. In another embodiment, each first end portion 29 may form an upper end portion of the corresponding support member 24 when the scissor linkage 14 is in the extended position, and each second end portion 30 may form a lower end portion of the corresponding support member 24 when the scissor linkage 14 is in the extended position. In yet another embodiment, the support members 24 of each crisscrossed pair of support members may be oriented or arranged oppositely. In that regard, the first end portion 29 of one support member 24 of a particular crisscrossed pair may form a lower end portion when the scissor linkage 14 is in the extended position, and the first end portion 29 of the other support member 24 of the particular crisscrossed pair may form an upper end portion when the scissor linkage 14 is in the extended position. In still yet another embodiment, one or both support members 24 of a particular crisscrossed pair of support members may include bent end portions that each define a pivot location (i.e., both end portions of the support member 24 may be formed like the first end portion 29), and one or both support members 24 of another crisscrossed pair of support members may include bent end portions formed like the second end portion 30 with a pivot support structure 34 attached thereto.

Referring to FIGS. 2 and 4, for each set of support members 24 of the illustrated embodiment, the pivot locations 32 of the first end portions 29 of the first pair 24a of crisscrossed support members are pivotally attached to the base 12. In that regard, the base 12 may include any suitable connection or articulation locations 36 for connection with the first pair 24a of crisscrossed support members of each set. For example, the base 12 may include two fixed articulation locations 36a (e.g., at a front end of the base 12) that each define a fixed pivot point for connection with the first end portion 29 disposed at a front side of a respective first pair 24a of crisscrossed support members, and two articulation locations 36b (e.g., at a rear end of the base 12) that are each configured to movably receive the first end portion 29 disposed at a rear side of a respective first pair 24a of crisscrossed support members. For example, the articulation locations 36b may be formed as channels that slidably receive sliders or rollers attached to the pivot locations 32 of the first end portions 29 at the rear side of the first pairs 24a of crisscrossed support members. The articulation locations 36 may be formed in a body portion of the base 12 or in support members, such as brackets, that are attached to the body portion. In another embodiment, all of the articulation locations on the base 12 may be configured to movably receive portions (e.g., first end portions 29) of the scissor linkage 14.

For each set of support members 24, the second end portion 30 of each support member 24 of the first pair 24a of crisscrossed support members is pivotally attached to the first end portion 29 of a respective support member 24 of the second pair 24b of crisscrossed support members with any suitable connection member, such as a pivot pin 38 (e.g., outer pivot pin). Likewise, for each set of support members 24, the second end portion 30 of each support member 24 of the second pair 24b of crisscrossed support members is pivotally attached to the first end portion 29 of a respective support member 24 of the third pair 24c of crisscrossed support members with any suitable connection member, such as a pivot pin 38 (e.g., outer pivot pin). For each of the first and second pairs 24a and 24b, respectively, of crisscrossed support members, each second end portion 30 may be attached to the first end portion 29 of a respective support member 24 at the pivot location 32 of the respective support member 24 so that the connected support members are each pivotable about a pivot axis (e.g., end pivot axis) 40 that extends through the pivot location 32 of the respective support member 24 (see FIG. 5). Furthermore, referring to FIG. 5, for each second end portion 30 that is attached to a respective first end portion 29, the second end portion 30 may be generally aligned with the first end portion 29 when viewed from above, so that an upright or vertical plane (not shown) may intersect the end portions 29 and 30 and the pivot axis 40. In addition, for each second end portion 30 that is attached to a respective first end portion 29, the first end portion 29 may be configured as a male end portion, and the pivot structure 34 attached to the second portion 30 may define a female receptacle that receives the male end portion.

Referring to FIGS. 2 and 4, for each set of support members 24, the second end portion 30 of each support member 24 of the third pair 24c of crisscrossed support members is attached to the work platform assembly 16. For example, each of those second end portions 30 may be pivotally attached to the work platform assembly 16 in any suitable manner, such as described below in detail.

As further shown in FIG. 4, the two sets of support members 24 may also be connected together using any suitable connection members 41, such as laterally extending rods, bars or braces.

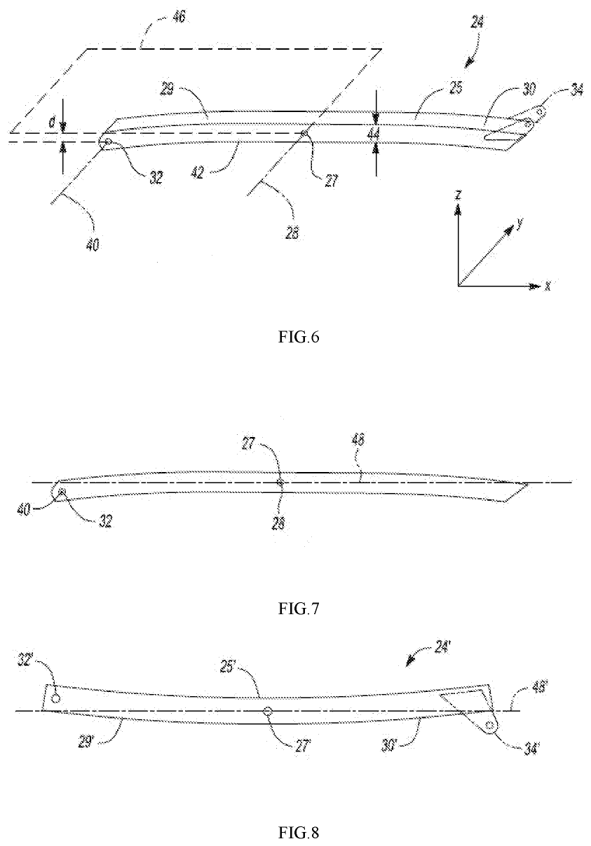

Referring to FIGS. 6 and 7, additional details of one of the support members 24 will now be described, with the understanding that the other support members 24 may have the same or similar configuration. In the illustrated embodiment, the support member 24 includes a tubular body with a straight main body portion 42 that forms the central portion 25, and the end portions 29 and 30 are disposed at opposite ends of the straight main body portion. The support member 24 has a height 44 at the central portion 25 (e.g., from a top surface to a bottom surface of the central portion 25 and extending through the central pivot location 27), and, when the support member 24 is in a generally horizontal orientation (e.g., when an associated lift device is positioned on level ground and the scissor linkage 14 is in the retracted position), the pivot axis 40 of the pivot location 32 of the first end portion 29 of the support member 24 may be offset with respect to a horizontal plane 46 that extends through the central pivot axis 28 by a distance d that is at least 25 percent of the height 44, for example. While the height 44 may be any suitable height depending on a particular application, the height 44 in one embodiment may be in a range of 5 cm to 38 cm. As another example, the pivot axis 40 of the pivot location 32 of the first end portion 29 of the support member 24 may be offset with respect to the horizontal plane 46 by a distance d in a range of 40 percent to 70 percent of the height 44. Likewise, the second end portion 30 may also be offset with respect to the horizontal plane 46 so that it won't intersect with a bent support member 24 that may be positioned above, when the corresponding scissor linkage 14 is in the retracted position.

Referring to FIG. 7, which shows a side, cross-sectional view of the support member 24 with the pivot support structure 34 removed, both end portions 29 and 30 are likewise offset with respect to a longitudinal axis 48 that extends through the central portion 25. The longitudinal axis 48 shown in FIG. 7 may be contained in the horizontal plane 46 shown in FIG. 6 when the support member 24 is in the generally horizontal orientation (e.g., when an associated lift device is positioned on level ground and the scissor linkage 14 is in the retracted position). In the illustrated embodiment, each end portion 28 and 30 is bent with respect to the central portion 25 and the longitudinal axis 48 so that each end portion 28 and 30 extends downwardly with respect to the longitudinal axis 48 when the support member 24 is in the horizontal orientation. Furthermore, the longitudinal axis 48 shown in FIG. 7 intersects the central pivot axis 28 of the central portion 25.

A method of making the scissor linkage 14 will now be briefly described. First, each support member 24 may be formed in any suitable manner. For example, the central portion (e.g., the straight main body portion 42) and the end portions 29 and 30 of each support member 24 may be formed as a single piece. In that regard, for each support member 24, a section (e.g., tubular section) of suitable material, such as metal (i.e., a metal or metal alloy, such as aluminum, aluminum alloy, steel, stainless steel, etc.), may be cut to a desired length, and then one or both of the end portions 29 and 30 may be bent with respect to the central portion 25 using any suitable process, such as punching (e.g., using a suitable punch press), hydroforming (e.g., using high-pressure hydraulic fluid and a suitable die or mold) and/or roll-forming (e.g., using one or more rolls), so that one or each end portion 29 and 30 includes at least one bend. In the embodiment shown in FIGS. 6 and 7, the end portions 29 and 30 are each formed as arcuate or curved end portions with a relatively large radius of curvature (e.g., each end portion 29 and 30 includes a bend of the at least one bend, and the bend provides the end portion 29, 30 with an arcuate or curved configuration). Furthermore, for each support member 24, the end portions 29 and 30 and the central portion 25 may form a concave configuration.

The pivot location 32 for each support member 24 may be integrally formed in the support member 24, such as by drilling or otherwise forming an opening or hole through the first end portion 29 of the support member 24, before or after the bending process. Likewise, the central pivot location 27 for each support member 24 may be integrally formed in the support member 24, such as by drilling or otherwise forming an opening or hole through the central portion 25 of the support member 24, before or after the bending process. In addition, the pivot support structure 34 for each support member 24 may be attached to the second end portion 30 of the support member 24, such as by welding, before or after the bending process. Next, the support members 24 may be attached together as explained above to form the scissor linkage 14. Furthermore, the scissor linkage 14 may be attached to the base 12 and the work platform assembly 16 to form the lift device 10.

With the above method, support members 24 may be made so that each support member 24 generally has a concave configuration. Furthermore, with a one-piece configuration for the body (e.g., tubular body) of each support member 24 that defines the central portion 25 and the end portions 29 and 30, the pivot locations 27 and 32 may be formed directly in a continuous wall (e.g., side wall) of the body.

The above support member configuration and method may provide numerous benefits. For example, because no pivot structure may need to be attached to the first end portion 29 of each support member 24, manufacturing costs may be reduced. In that regard, as noted above, the first end portion 29 of one support member 24 may define a pivot location 32 that may be connected to the second end portion 30 (e.g., pivot structure 34 attached to the second portion 30) of another support member 24 with a pivot pin 38. In other words, the pivot structure 34 of the another support member 24 may be connected directly to the pivot location 32 of the one support member 24. Furthermore, because the first end portion 29 of each support member 24 may be formed without additional structure welded at or near the pivot location 32, stress at the first end portion 29 may be significantly reduced compared to prior scissor linkage designs. In addition, the bent end portions 29 and 30 of each support member 24 may smoothly transfer stress from respective pivot attachment locations (e.g., the pivot location 32) to other areas of the support member 24 (e.g., the central portion 25 or main body portion 42). As a result, the scissor linkage 14 may be more durable than prior designs. Still further, the end portions 29, 30 of adjacent support members 24 may nest together when the scissor linkage 14 is in the retracted position, so that the scissor linkage 14 may provide an attractive appearance.

Returning to FIGS. 1-4, additional features of the lift device 10 will now be described. The lift device 10 may include one or more actuators, such as hydraulic cylinders, pneumatic cylinders, electric linear actuators, etc., associated with the scissor linkage 14 and configured to move the scissor linkage 14 from the retracted position to the extended position or between the retracted position and the extended position. In the illustrated embodiment, the lift device 10 includes an actuator 50 mounted to different support members 24 or different pairs of support members 24. Specifically, the actuator 50 has a first end connected between the first pairs 24a of crisscrossed support members of the two sets of support members (e.g., connected to a laterally extending member, such as a rod, bar or brace, that is connected to the first pairs 24a of crisscrossed support members) and a second end connected between the third pairs 24c of crisscrossed support members 24 of the two sets of support members (e.g., connected to a laterally extending member, such as a rod, bar or brace, that is connected to the third pairs 24c of crisscrossed support members). Furthermore, the actuator 50 is movable between a retracted position and an extended position for moving the scissor linkage 14 from the retracted position to the extended position.

In another embodiment, the lift device 10 may include one or more actuators connected between the base 12 and one or more of the support members 24. In yet another embodiment, the lift device 10 may include any combination of the above described actuators. For example, the lift device 10 may include one or more actuators connected between the base 12 and one or more of the support members 24, and/or one or more actuators mounted to different support members 24. In any case, the one or more actuators for moving the scissor linkage 14 may be considered part of the scissor linkage 14.

Referring to FIGS. 1 and 2, the work platform assembly 16 is coupled (e.g., directly or indirectly) to the scissor linkage 14 and includes a support member, such as base or work platform 52, and a control system 54 associated with the platform 52 for controlling operation of the lift device 10 (e.g., operation of the drive system 20, operation of the steering system 22, movement of the platform 52 via the scissor linkage 14 and/or movement of the platform 52 with respect to the scissor linkage 14). The work platform 52 is movable with respect to the base 12 between a lowered position, shown in FIG. 1, and a raised position, shown in FIG. 2, when the scissor linkage 14 is moved between the retracted and extended positions, respectively. While the work platform assembly 16 may be coupled to the scissor linkage 14 in any suitable manner, in the illustrated embodiment, the platform 52 includes two fixed connection or articulation locations 56a (e.g., at a front end of a base of the platform 52) that each define a fixed pivot point for connection with the second end portion 30 disposed at a front side of a respective third pair 24c of crisscrossed support members 24, and two connection or articulation locations 56b (e.g., at a rear end of the platform 52) that are each configured to movably receive the second end portion 30 disposed at a rear side of a respective third pair 24c of crisscrossed support members 24. For example, the articulation locations 56b may be formed as channels that slidably receive sliders or rollers attached to the second end portions 30 (e.g., attached to the pivot structures 34) at the rear side of the third pairs 24c of crisscrossed support members 24. The platform 52 of the work platform assembly 18 is sized to receive an operator

thereon. A railing assembly or frame assembly 58 is provided on the platform 52, and the frame assembly 58 includes one or more guard members or rails (e.g., toe-boards, middle rails and top rails) that cooperate to contain the operator within the frame assembly 58. The frame assembly 58 may also include a movable (e.g., pivotable) door to allow operator ingress to, and egress from, the work platform assembly 16.

The control system 54 may include any suitable controls for controlling operation of the lift device 10. For example, the control system 54 may include a control unit 60 (e.g., electronic control unit, control box or control panel) mounted on or supported by the platform 52 and having one or more controls, such as buttons, switches, wheels, levers (e.g., joysticks), etc., for inputting control commands. The control system 54 may also include one or more other control units positioned at other locations on the lift device 10. Furthermore, the control system 54 may include any suitable hardware and/or software for controlling operation of any of the above described systems, mechanisms, arrangements or other components. For example, the control system 54 may include one or more processors in communication with, or configured to communicate with, one or more storage devices or memory units, which include computer readable program instructions that are executable by the one or more processors so that the control system 54 may control operation of the scissor linkage 14, the drive system 20, the steering system 22, etc. The control system 54 may also, or instead, include one or more application specific integrated circuits, programmable gate arrays, programmable logic devices, and/or digital signal processors.

Referring to FIGS. 8-10, additional example support member embodiments according to the disclosure are shown, and each of these embodiments may be used with a scissor linkage or a lift device according to the disclosure. In that regard, FIGS. 8-10 each show a single support member that is representative of each of multiple support members that could be connected together in the above-described manner, or similar manner, and used in a particular scissor linkage or lift device according to the disclosure. Similar features between the below embodiments and the above described support members 24 are identified with similar reference numbers. Furthermore, each of the support member embodiments shown in FIGS. 8-10 may provide one or more of the benefits described above with respect to the support members 24 and scissor linkage 14.

In the embodiment shown in FIG. 8, support member 24′ has a body portion that includes central portion 25′ and end portions 29′ and 30′, and the body portion is bent so that it has a continuous arcuate shape or configuration from one end to the opposite end, including first end portion 29′ and second end portion 30′. Nonetheless, the end portions 29′ and 30′ are each offset with respect to the central portion 25′, and more specifically, with respect to a longitudinal axis 48′ that extends through the central portion 25′. This configuration may enable smooth transfer of stress from one end of the support member 24′ to the other end.

In the embodiment shown in FIG. 9, support member 24″ includes a bent central portion 25″ and straight first and second end portions 29″ and 30″, respectively. In this embodiment, the central portion 25″ includes at least one bend that causes one or both of the end portions 29″ and 30″ to be offset with respect to a longitudinal axis 48″ that extends through the central portion 25″.

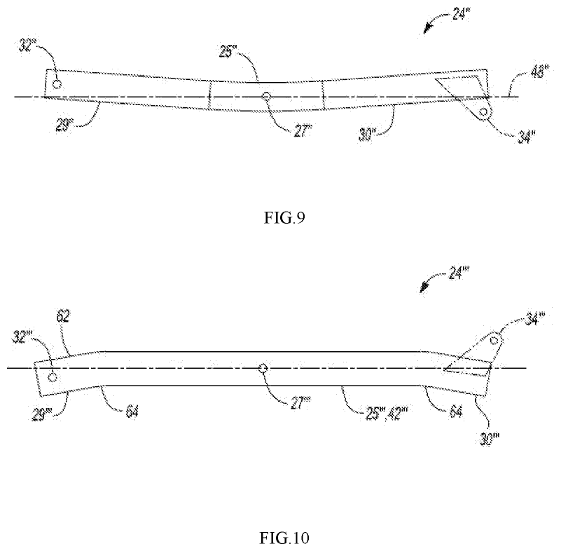

FIG. 10 shows yet another embodiment 24′' of a support member according to the disclosure. The support member 24′″ includes a straight main body portion 42′″ and bent first and second end portions 29″ and 30″, respectively, that each include one or more straight sections and/or one or more curved sections. In the illustrated embodiment, each bent end portion 29″ and 30″ includes a straight section 62 and a curved section 64 in between the straight section 62 and the main body portion 42′″.

It should be noted that any of the above described embodiments can be oriented in any suitable manner. In that regard, the embodiments shown in FIGS. 8 and 9 could each be rotated 180° so that the corresponding end portions extend downwardly, rather than upwardly, when the support members are in a generally horizontal orientation (e.g., when the corresponding scissor linkage is in the retracted position). Likewise, the embodiment shown in FIG. 10 could also be rotated 180° so that the corresponding end portions extend upwardly rather than downwardly. Furthermore, for each of the above described embodiments, one end portion may extend downwardly, and the other end portion may extend upwardly when the support member is in the generally horizontal orientation.

In addition, each of the above described support member embodiments could be made in any suitable manner, such as described above with respect to the support members 24. For example, the central portion and first and second end portions of each support member shown in FIGS. 8-10 may be formed as a single piece that is bent as needed (e.g., to include at least one bend) to form the desired configuration.

Each of the above-described embodiments may also be generally described in a similar manner, with respect to a plane and/or a longitudinal axis of the particular support member, as the support member 24. For example, each of the support members shown in FIGS. 8-10 has a height at the respective central portion of the support member, and, when the support member is in a generally horizontal orientation (e.g., when an associated lift device is positioned on level ground and the corresponding scissor linkage is in the retracted position), the pivot axis of the pivot location of the respective first end portion of the support member may be offset with respect to a horizontal plane that extends through the central pivot axis by a distance that is at least 25 percent of the height at the respective central portion, or in a range of 40 percent to 70 percent of the height at the respective central portion, for example.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. A scissor linkage comprising:
a first support member including a first central portion and a first end portion having a first end pivot location, wherein the first support member has at least one bend so that the first end portion is offset with respect to a longitudinal axis that extends through the first central portion; and
a second support member having a second end portion attached to the first end portion of the first support member at the first end pivot location of the first support member so that the second support member is pivotable about a pivot axis that extends through the first end pivot location of the first support member.

2. The scissor linkage of claim 1 wherein the second end portion of the second support member is generally aligned with the first end portion of the first support member, when viewed from above.

3. The scissor linkage of claim 1 wherein the first central portion of the first support member comprises a straight main body portion, and the first end portion is bent with respect to the straight main body portion.

4. The scissor linkage of claim 1 wherein the first central portion of the first support member has a first height and a first central pivot location for pivotal attachment to another support member, and the at least one bend of the first support member is configured so that, when the first support member is in a generally horizontal orientation, the pivot axis of the first end pivot location of the first end portion of the first support member is offset with respect to a horizontal plane that extends through the first central pivot location by a distance that is at least 25 percent of the first height.

5. The scissor linkage of claim 4 wherein, when the first support member is in the generally horizontal orientation, the pivot axis of the first end pivot location of the first end portion of the first support member is offset with respect to the horizontal plane by a distance in a range of 40 percent to 70 percent of the first height.

6. The scissor linkage of claim 1 wherein the second support member includes a second central portion and at least one bend so that the second end portion is offset with respect to a longitudinal axis that extends through the second central portion.

7. The scissor linkage of claim 1 wherein the first end portion of the first support member comprises a bend of the at least one bend so that the first end portion is formed as a curved end portion.

8. The scissor linkage of claim 1 wherein the first end portion of the first support member comprises at least one straight section and a bend of the at least one bend.

9. The scissor linkage of claim 1 wherein the first end portion of the first support member comprises a bend of the at least one bend, and the bend is configured as an arcuate section.

10. The scissor linkage of claim 1 wherein the first central portion comprises a bend of the at least one bend.

11. The scissor linkage of claim 1 wherein the at least one bend of the first support member is configured so that the first support member has an arcuate shape from end to end of the first support member.

12. The scissor linkage of claim 1 wherein the first support member comprises a one-piece tubular body that defines the first central portion and the first end portion, and the first end pivot location is formed in a wall of the tubular body.

13. A lift device comprising:
a base;
the scissor linkage according to claim 1 attached to the base, wherein the scissor linkage is movable between a retracted position and an extended position; and
a platform attached to the scissor linkage, wherein the platform is movable with respect to the base between a lowered position and a raised position when the scissor linkage moves between the retracted position and the extended position.

14. The lift device of claim 13 wherein the first end portion of the first support member and the second end portion of the second support member extend downwardly when the scissor linkage is in the retracted position.

15. The lift device of claim 13 wherein the first end portion of the first support member nests with the second end portion of the second support member when the scissor linkage is in the retracted position.

16. The lift device of claim 13 wherein the scissor linkage includes an additional support member pivotally attached to the first central portion of the first support member so that the additional support member and the first support member are pivotable with respect to each other about a central pivot axis, wherein the first support member has a first height at the first central portion, and wherein, when the lift device is on level ground and the scissor linkage is in the retracted position, the pivot axis of the first end pivot location of the first end portion of the first support member is offset with respect to a horizontal plane that extends through the central pivot axis by a distance in a range of 40 percent to 70 percent of the first height.

17. A lift device comprising:
a base;
a scissor linkage attached to the base and movable between a retracted position and an extended position, wherein the scissor linkage includes first and second pairs of crisscrossed support members, each support member of the first pair of crisscrossed support members has a first end portion having a first end pivot location, and a first central portion having a first height and a first central pivot location, the first central pivot locations of the first pair of crisscrossed support members are attached together so that each support member of the first pair of crisscrossed support members is pivotable about a first central pivot axis that extends through the first central pivot locations, and each of the support members of the second pair of crisscrossed support members has a second end portion that is attached to the first end portion of a respective support member of the first pair of crisscrossed support members at the first end pivot location of the respective support member so that each of the support members of the second pair of crisscrossed support members is pivotable about a pivot axis that extends through the first end pivot location of the respective support member of the first pair of crisscrossed support members, and wherein each support member of the first pair of crisscrossed support members is bent so that, when the lift device is on level ground and the scissor linkage is in the retracted position, the pivot axis of each first end pivot location of the first pair of crisscrossed support members is offset with respect to a horizontal plane that extends through the first central pivot axis by a distance in a range of 40 percent to 70 percent of the first height; and
a platform attached to the scissor linkage, wherein the platform is movable with respect to the base between a lowered position and a raised position when the scissor linkage moves between the retracted position and the extended position.

18. A method of making a scissor linkage, the method comprising:
bending a first support member having a first central portion and a first end portion so that the first end portion is offset with respect to a longitudinal axis that extends through the first central portion, wherein the first end portion defines a first end pivot location; and
attaching a second support member to the first end portion of the first support member at the first end pivot location so that the second support member is pivotable with respect to the first support member about a pivot axis that extends through the first end pivot location.

19. The method of claim 18 wherein the first support member comprises a one-piece tubular body that defines the first central portion and the first end portion.

20. The method of claim 18 wherein the bending is performed so that the first end portion of the first support member forms a curved end portion.

21. The method of claim 18 wherein the first central portion of the first support member has a first height and a first central pivot location for pivotal attachment to another support member, and the bending is performed so that, when the first support member is in a generally horizontal orientation, the pivot axis of the first end pivot location of the first end portion of the first support member is offset with respect to a horizontal plane that extends through the first central pivot location by a distance that is at least 25 percent of the first height.

22. The method of claim 19 wherein, when the first support member is in the generally horizontal orientation, the pivot axis of the first end pivot location of the first end portion of the first support member is offset with respect to the horizontal plane by a distance in a range 40 percent to 70 percent of the first height.
